(19) United States
(12) Patent Application Publication
(10) Pub. No.: US 2025/0014476 A1
(43) Pub. Date: Jan. 9, 2025

(54) Method for uploading musical pitch in the brain.

(71) Applicant: David J Roskoph, SUGAR LAND, TX (US)

(72) Inventor: David J Roskoph, SUGAR LAND, TX (US)

(21) Appl. No.: 18/121,784

(22) Filed: Jul. 3, 2023

(51) Int. Cl. G09B 15/02; G09B 15/04

(52) U.S. Cl. CPC G09B 15/023; G09B 15/04

(57) ABSTRACT

A method and system of fast learning of optimized pitch through immersive and repeated exposure of babies/kids' brain (upto 7 years of age) to slow neural firing frequency of labelled musical sounds to enable pair unconscious acquisition with conscious stimulus within the brain. The said method and system also allows parental control of the music sounds through a filtration process aided by on-screen information.

### FIELD OF THE INVENTION

The present invention involves a system and method for attaining musical absolute pitch, primarily by children. Further, the said system and method allows correlation of image and sound in a way to enable simultaneous perception of both symbol and sound.

### BACKGROUND OF THE INVENTION

Musicians increase their musical ability through apt identification of musical tones by creating selected musical tones mentally and physically. Accurate recognition and reproduction of specific tones is critically important for singers or instrumentalists whose music relies on subtle brain mechanics. Musicians often improve their musicality via separate tools and methods for ear training. Apart from and in addition to their production and reception of music, musicians drill to become more able to identify musical notes by repetitively listening to, then attempting to identify them.

In that context, recognition of absolute pitch becomes indispensable. Perfect or Absolute Pitch is the rare ability to identify a note/chord without reference to any other notes or chords. Since inception, absolute pitch training has been a form of ear training. Scientists and educators have attempted to map/identify absolute pitch ability for over one hundred years with limited success. The conventional ear-training methods, including absolute pitch training, generally require subjects to memorize and identify tone sounds. For instance, a tone or series of tones is sounded, and the Subject is required to identify the tones. The form of the identification is typically a linguistic label, either a letter name (e.g., “G”, “B-flat”, “F-sharp’) or asolfege syllable (e.g., “do”, “la”, “sol). As an alternate method of identification, some methods have also attempted to map associations between tone sounds and visual colors, or motor associations between tone sounds and gestural movements. Although some presentation-response modes are more efficient than others, they all follow the same basic methodical model by requiring their subjects to identify tones. The methods vary in the mode of presentation and manner of response required. The tones may be presented by the musician, a human partner, a computer, or other Suitable electronic machine. The Subject's responses may be given vocally or kinesthetically (such as pressing a key or button).

Several utility patents in the ascertaining of absolute pitch are in examined in this context.

In US20120198986 titled, “Method/Apparatus for training absolute pitch, electronic musical instrument and sound source processing apparatus” relate to a method and an apparatus for training an absolute pitch, to an electronic musical instrument, and to a sound source processing apparatus. According to one embodiment of the present invention, an absolute pitch training apparatus is provided, comprising: an output request input unit for taking, as an input, an output request for a specific sound; an overtone output unit for outputting an overtone, the number of vibrations of which is greater than the basic number of vibrations for a specific sound; and a compound tone output unit for outputting a compound tone in which a fundamental sound, having a basic number of vibrations, and an overtone for a specific sound are mixed. According to one embodiment of the present invention, an absolute pitch training method for training an absolute pitch is proposed, enabling persons necessarily requiring an absolute pitch to train so as to achieve an absolute pitch.

In US20070017351A1 titled, “Musical absolute pitch recognition instruction system and method” comprises a system and method that describes an ear training system and method designed to teach a subject the ability to recognize and perceive absolute pitch. The system and method present a melody word including a target pitch. The subject is then exposed to a query sound. The subject is then tasked to determine whether the target pitch is present in the query sound. A reinforcing sound and/or a visual indicia associated with the target pitch may be provided to assist the subject in determining the presence of the target pitch in the query sound.

While the literature talks about attempts to identify absolute pitch none talks of a system and method of teaching children (especially under 5 years of age) wherein the challenge of teaching children the absolute pitch in a focused manner is examined. The present invention tries to portray mentioned method and system.

### SUMMARY OF THE INVENTION

An aspect of the invention is to develop a method and system for learning musical sound categorization in a way towards understanding absolute pitch for babies and children, of up to 7 years of age and immediate beyond.

Further aspect of the invention involves utilizing the synchronized cortex and limbic parts of a child's brain through slow neural firing frequency of 4 to 7 cycles per second termed as Theta, that is present in the dominant frequency of children until approximately age 7.

In another aspect of the invention, the said continual neural firing entail immersion and repeated exposure of a child to enable attain the absolute pitch.

In further aspect of the invention, the said method and system categorize the musical sounds by applying a specific label to each such sound of various image duration.

An aspect of the invention is to label each sound through quick association of letters and words to the sounds to enable a child pair his/her unconscious acquisition with the conscious stimulus.

In further aspect of the invention, such conscious stimulus is made to be perceived by presenting symbol images from 7-200 milliseconds. The particular rate allows perception of the sound images slightly above the minimum visual perception threshold of 5 milliseconds to ensure media is physically perceived by the learning child.

In another aspect of the invention, the method and system for presenting sound images are done on a simultaneous basis through usage of the letter of the note/chord, and the treble clef Staff image of the note/chord keyboard.

In an aspect of the invention, the said method allows installation of Absolute Pitch notes in a way to enable professionally achieve the same by a learner child in the shortest possible time through a tailored form controllable by parents of learner-children.

Further aspect of the invention states the creation of a log for each piece of music filtered through a musical wheel by learner children as part of the method and system in ascertaining Absolute Pitch.

Final aspect of the invention also mentions the aspect of on-screen information display during the filtration process by a child through a cue of music. The present invention though specifically targeted for babies and children, but can be extended for adults also, given the recent studies enhancing adult acquisition of absolute pitch through chemical agents that recreate juvenile neural plasticity. This can be used in combination with such plasticity-enabling drugs for subjects above age 7.

### BRIEF DESCRIPTION OF THE FIGURES

FIGS. 1 and 2: Identification of notes on score and/or corresponding keys

FIGS. 3 and 4: Placing any of the three images on the sound wave representing that note.

FIG. 5: Raw sound signature for entire piece

FIG. 6: Musical Wheel showing the music being played along with its various parameters

FIG. 7: Musical wheel with the 4 buttons for filtering most appropriate musical note

FIG. 8: On screen information for choosing various individual notes on the wheel

FIG. 9: Basic functioning of the Musical Wheel wherein the Player is specifically designed as an easy-to-use educational tool for parents of toddlers and young children. The system will be available in both desktop and mobile versions that contain the same functions.

### DETAILED DESCRIPTION OF THE INVENTION

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all 1 modifications, equivalents, and alternatives falling within the scope of example embodiments. Like numbers refer to like elements throughout the description of the figures.

Provided herein is a method and system for labelling of musical sounds by quickly associating letters and symbols to the basic musical sounds to enable the same understood easily by babies and children up to 7 years of age. History and experience prove that the acquisition of absolute Pitch occurs sometime before age 7 and immediate beyond but there are no known formal studies.

The present invention is based partially on the established science that children experience a golden era of learning through age 7 and, it is presumed to be related to the prevalence of Theta brainwaves in the developing brain. The present invention seeks to exploit the association between Theta brainwaves and unconscious and or effortless learning. In Theta children unconscious “uploading” of an enormous amount of information including language and culture occurs. As to why this is time specific remains unknown. Contemporary science attributes it to a specific, individual neuronal maturity arcs or windows. The present invention posits how the prevalence of Theta brainwaves facilitates accelerated acquisition through the once-in-a-lifetime, extended synchronization of the limbic brain and the developing cortex. In such a context, learning capacity of children is almost untouched with contemporary methods, which do not attempt to influence the child's mind through subconscious stimulus. As few children can attend to formal music lessons as toddlers, when absolute pitch is known to be occurring, that they are learning subconsciously is almost a given dictum.

In that objective, the said method and system capitalizes on the unconscious acquisition/learning by pairing it with a pleasant, conscious stimulus, to label the 36 primary sounds that comprise the foundation of musical pitch, 12 notes, their major and minor chords. The said method allows influencing the stimulus that is not consciously processed or even perceived in the same fashion by a child, as s/he embodies language acquisition, wherein the connections are reserved in the development of a neural network for the sound, which is subsequently coded with a symbol. A child's brain is literally exploding with synaptic connections that are making sense of what it perceives. Such a state, known as a neural bloom, starts in the third trimester before birth through about age two, when the most salient connections remain while others start to get pruned. Further, it is well established that the “Critical Period” for language begins at the inception of the neural bloom until about 48 months. This is because the young mind is designed to acquire language at precisely that time, to ensure its future. The mechanism of language and pitch do have overlap on the map of the brain but also occupy certain distinct regions. The pertinent aspect of language and absolute pitch acquisition is that they are both time critical. The architecture of the developing brain quickly learns what is and, what is not important, fortifying the former and pruning the latter. In other words, the brain is fortifying pertinent stimulus and learning to ignore the others. The sounds of language are given ever-more context as the child matures because they are emerging into that as part of their cultural assimilation. That is usually not the case for the music they hear during their Critical Period. As stated, exactly when absolute pitch is learned in the young mind is unknown though the present invention seeks to establish pitch sensitivity as early as possible, then protect the neuronal connections associated with absolute pitch, through the pruning process. The present invention is not a once exposure or intended as irregular exposure. Rather, exactly like language acquisition, pitch acquisition is almost certainly acquired through a continuing process, Further, this invention seeks to establish and reserve the neuronal connections, which act like germinating seed of a tonal language, intended to be strengthened though formal musical training once the child is mature enough to participate. However, once acquired, absolute pitch may remain without nurturing in the adolescence stage.

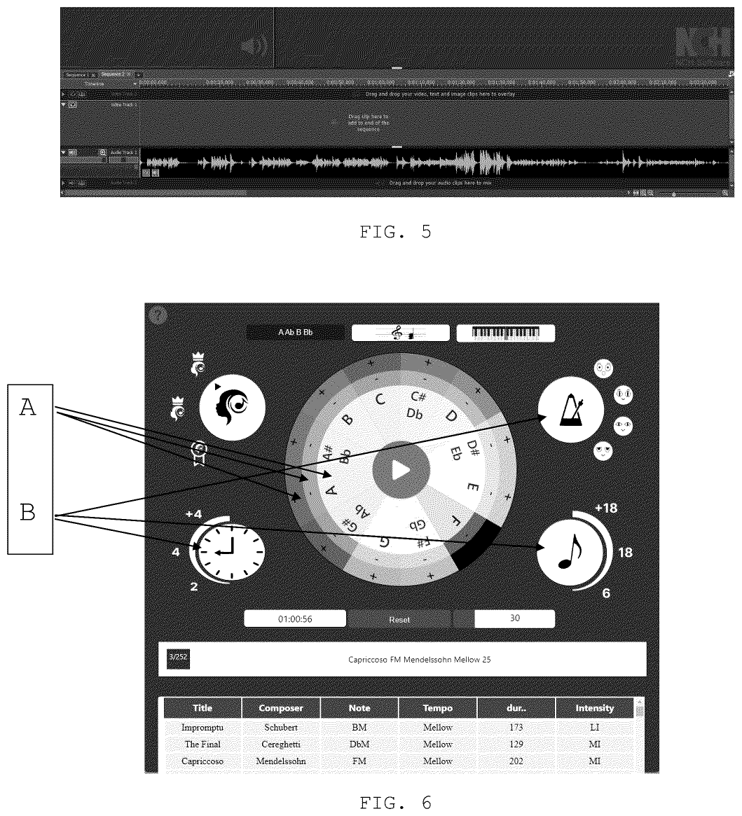

In an embodiment of the present invention and in reference to FIG. 5, the images of the musical notes vary from 7-200 milliseconds at which, taken the frame refresh rate of most appliances, the images may become briefly visible. The repetitive, simultaneous audial and visual stimulus, conscious and unconscious, enable coding of that individual frequency with a label. Allowing for the expansion of any given note labelling, three representations of any of the 36 notes or chords is provided, intended to be used individually. For any given session, users can select 1) the Letter of the note/chord, 2) the treble clef Staff image of the note/chord or 3) highlighted Keys on a piano keyboard of the note/chord. The said system of arousal of child's brain consciously varies from language to language.

For example, native Mandarin speaking children have ˜1:3,000 probability of acquiring absolute pitch, whereas the probability is much lower for non-tonal languages such as English. The probability statistics of ˜1:300 or ˜1:10,000 are generally accepted as there is no concrete number due to the rarity of absolute pitch. It is anticipated to have greater efficacy for children raised with a tonal language as the process resembles the coding of musical pitch.

To a learner child, said labels allow correlation of image and sound in a way to enable simultaneous perception of both symbol and sound. Moreover, three musical images for the parents to use 1) the Letter of the note/chord, 2) the treble clef Staff image of the note/chord and 3) highlighted Keys on a piano keyboard of the note/chord.

In further embodiment of the present invention, installation of absolute pitch is incorporated through treble clef notes exclusively (as opposed to both Bass and Treble)

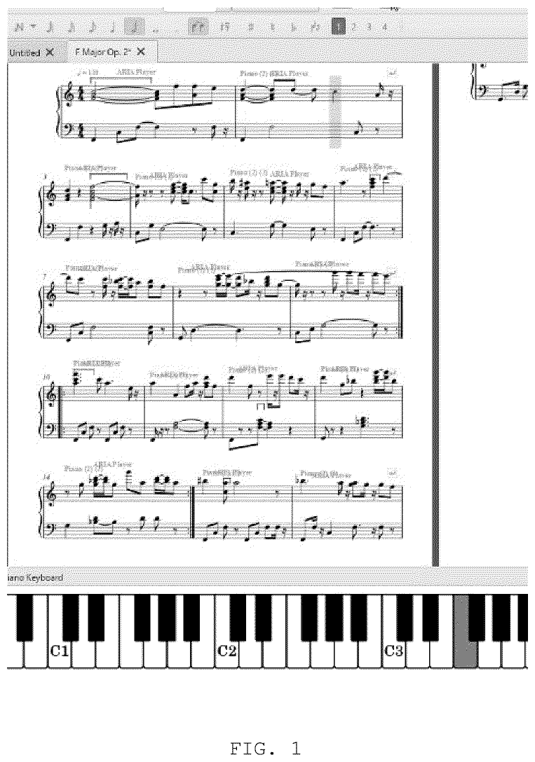

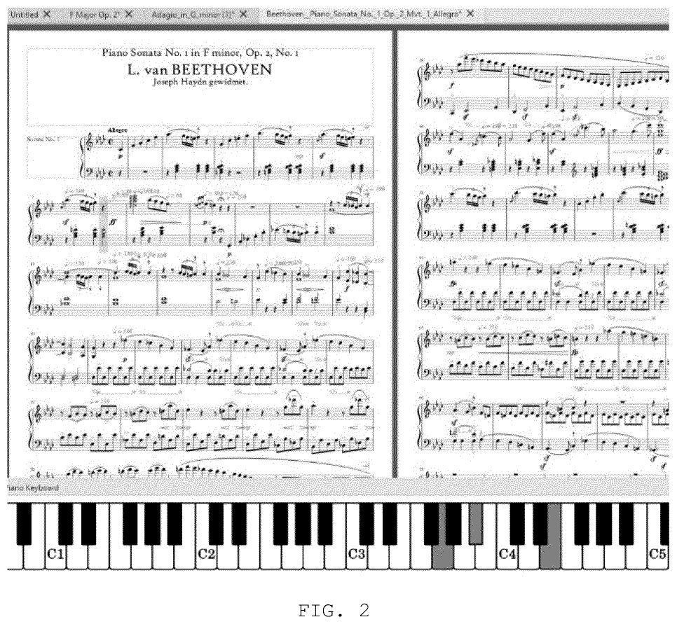

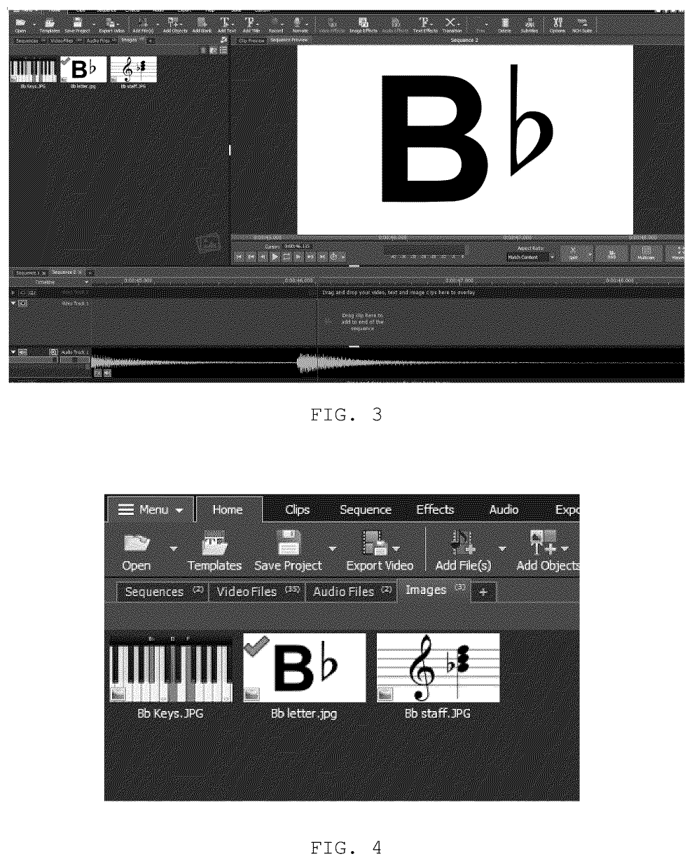

The treble clef isolates the notes/chords of music that is are being paired. In some pieces the bass clef (audio only) is retained if it does not interfere with the image isolation process. Additionally, music is chosen to offer image frequency across abroad range of intervals as the efficacy of this method will be refined with use. The said objective is achieved by writing music in sheet form to enable clear identification of each note in both the treble and bass clef. There upon, the search 1 identification for the most pleasant pieces of classical music that lend themselves to this process with regularly occurring notes/chords is initiated. Once identified, a common music application to view these notes (FIGS. 1 and 2) as they appear on a graphical display as individual keys is registered. With a list of the note/chord as it appears in a music piece, the sound wave is registered graphically and placed as an image in the center of the visible sound wave on a video editing program, where it appears graphically (FIGS. 3 and 4). Though musical notes have different playing times in compositions, they are rarely less than 1/16th of a second, making the exact image placement possible.

Taken the fact, that a raw video containing only the notes, as they occur in each piece of music, is not very appealing to a toddler, the present invention, assembles short video clips that seek to match the tempo of the music being heard. In tune with it, the images of the musical notes are flashed over the video, which may or may not be visible to the viewer.

In another aspect of the present method and system, parents intending to deliver absolute musical notes to their children are tailored to build exact specifications in a series of steps. With reference to FIG. 6, a typical “player” is made to offer a complete education in small instalments, when convenient and in a controllable manner. The Player consists of a typical musical wheel consisting of 12 fundamental notes A, Ab, B, Bb, C, D, Db, E, Eb, F, G, Gb. There is a slight difference between sharps and flat chords ex C# and Db but for simplicity's sake they are combined into only flats (b). Above each of the 12 notes is its Major and Minor. Each of the 12 slices represents a family of notes such as A, A Major (+) and A Minor (−).

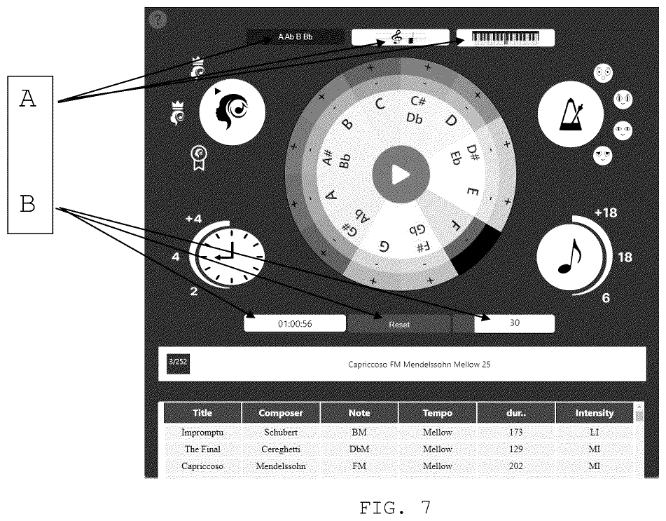

In further embodiment of the present invention and in reference to FIG. 7, there is another filtering system to select most appropriate musical notes through the four cardinal buttons in each corner outside the wheel. These allow for faster selections for mom's on-the-go. The top left button separates the library into Classics, Originals or All. The top right button allows users to choose the Tempo of the pieces from Calm to Mellow to Moderate the Lively. The bottom left selects based on the groups of notes or major chords or minor chords. The final button in the lower right is an entirely new feature peculiar to this system. Users can select the Intensity of the images within the musical pieces in terms of seconds separating images or images/second. From Low the Medium to High. These buttons can be used separately or in combination, for general or refined albums for each session.

Further embodiment of the present invention is the creation of a usage log. Such a creation of log is intended to be fun for toddlers and install their musical foundation in a concrete manner. Whether selected through the same buttons each day or as individual note, the system keeps a log of each piece of music played. In a classroom, teachers can go through the music in any order they believe best suits their students through the precision of the Musical Wheel. Parents can make sure they cover all the note and chords by referencing the log at any time to see how many times each not/chord was viewed. System automatically fills in matrix by deselecting pieces already played when the same filters are used. Meaning that the system keeps track of the library to ensure complete exposure to all notes, minor and major chords. Users can override this by focusing on any note or chord through the musical wheel.

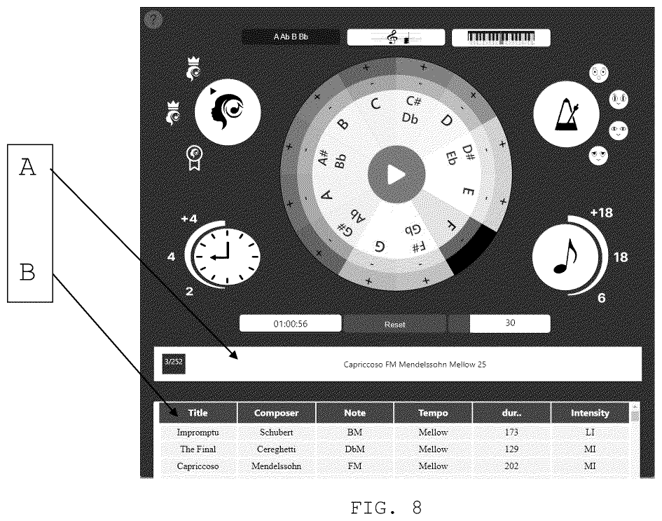

Another important embodiment of the present invention is the aspect of on-screen information (FIG. 8). Regardless of whether the users filter through the Musical Wheel in the center or the four buttons in the corners, they will see the working cue of songs that will play based on their selections. For example, if they choose only an individual note on the wheel, they will see the number of songs from the library available in that note, whether classical or original. In the wheel they can choose more than one of the three in each of the 12 segments. In each case, they will see the cue reflect the pieces in the note, and if they choose the major, then the note and the major etc. In the case of the four filter buttons, they work independently or in serial concert.

The final cue will be identical regardless of their using MIX first or last, TEMPO first or last etc, given the same inputs. The two filtering systems are designed to work separately, either the Musical Wheel or the four buttons.

The user will see the song being played as it plays and the cue of music to be played from using either filtering system. Additionally, regardless of filtration system, the Musical Wheel will also highlight the note or chord presently being played as referred in FIG. 9. A tally will be made of the Images to be played in the pending cue as well as the Images that have been played in the present session as an overall measure of exposure to the media.

Finally with reference to FIG. 7, the present invention also allows provision for testing the methodology through a mechanism to produce any of the 36 sounds on the Music Wheel (1). There is a tab extending into the 12 innermost notes, A-G (2). Pressed once, it plays the pure tone of that note, twice that note's minor chord and thrice, that note's major chord. The parents then show a chart of the 12 notes- or the 12 minor chords- or the 12 major chords for the child to select when the pure note is played. This sound, a pure tone, is not found in any of the pieces of the musical library and included as additional verification of their acquiring Absolute Pitch.

While the foregoing is directed to embodiments of the present invention, other and further embodiments of the invention may be devised without departing from the basic scope thereof, and the scope thereof is determined by the claims that follow.

### Diagrams

FIG. 1&2) Identification of notes on score and/or corresponding keys

FIG. 3&4) Placing any of the three images on the sound wave representing that note

FIG. 5) Raw sound signature for entire piece

FIG. 6A) Player Wheel-dual function. 1) notes/chords chosen for queue can be individual or by family ex A, A− minor and/or A+ major. 2) 36 individual spaces individually highlight when each played from queue

What is claimed is:

1. An absolute pitch recognition method for babies and kids up to 7 years of age, said method comprising:
slow neural firing frequency of 4 to 7 cycles per second in the synchronized cortex and limbic part of a typical baby/child's brain towards attaining an ultimate/absolute pitch. providing a label to the queried musical notes containing (or not) the targeted ultimate pitch through letters and words; and
enabling the subject to consciously input the labelled sound images for a period of 7 to 200 milliseconds to enable visualize the sound for apt immersion of the ultimate pitch present within the visualized sound.

2. The method of claim 1, further comprising the sound images to be accomplished on a simultaneous basis through usage of the letter of the note/chord, and the treble clef staff image of the note/chord, keyboard, containing (or not) the targeted ultimate pitch.

3. The method of claim 1, wherein the said treble clef is isolated specifically for isolating the note/chord in music towards attainment of the targeted absolute pitch.

4. The method of claim 1, further comprising the step of associating the targeted ultimate pitch with a usage log for each piece of music filtered through a musical wheel by learner kids and children.

5. The method of claim 1, wherein the targeted ultimate pitch is achieved by means of on-screen information display available to learner kids and children for apt filtration of musical sounds through a cue of music.

6. The method of claim 4, wherein the usage log may be customized by parents through a referencing process.
